(19) United States
(12) Patent Application Publication
(10) Pub. No.: US 2002/0064544 A1
(43) Pub. Date: May 30, 2002

(54) Antimicrobial compositions

(76) Inventors: John Lezdey, Indian Rocks Beach, FL (US); Jarett Lezdey, Indian Rocks Beach, FL (US)

Correspondence Address: JOHN LEZDEY, 1409 A NORTH FT. HARRISON, CLEARWATER, FL, 33755, US

(21) Appl. No.: 10/001,311

(22) Filed: Nov. 23, 2001

Related U.S. Application Data
(63) Continuation-in-part of application No. 09/491,224, filed on Jan. 25, 2000.

(51) Int. Cl. A01N 25/24; A01N 31/00; A01N 25/00; A01N 25/32; A01N 25/34; A01N 37/00; A01N 31/08

(52) U.S. Cl. 424/407; 514/730; 424/405; 424/406; 424/411; 424/78.09; 514/557; 514/731

(57) ABSTRACT

The invention provides antimicrobial composition which contain phenols complexed with polycarboxylic acid and a quaternary amine compound to form a long lasting film which can be sprayed on surfaces or combined with a polymer

### RELATED APPLICATION

This is a continuation-in-part of application Ser. No. 09/491,224 filed Jan. 25, 2000.

### FIELD OF THE INVENTION

The present invention relates to antimicrobial compositions comprising phenol and quaternary ammonium complexes. More particularly, there is provided compositions with novel complexes which render the same antimicrobial activity as the unreacted smaller molecule but are more hypoallergenic, have slower release and longer lasting. The complexes are especially useful in killing or deactivating microorganisms on contact and preventing growth of colonies over longer periods of time, including mildew and mold. There is further provided antimicrobial polymeric films.

### BACKGROUND OF THE INVENTION

There is a need to provide a safe and effective means for preventing viral, fungal and bacterial growth, which can be used on or near a person's body without adverse effects on the user. There is a further need to provide preparations, which will inhibit and/or prevent the growth of disease or odor causing viruses, bacteria and fungus.

There is a further need to provide longer lasting protection against infectious diseases caused by viruses and bacteria. New strains of viruses and bacteria are developing which are resistant to antibiotics. Therefore, it has become important as a defense to kill or deactivate them before infection.

Compositions that contain only phenol compounds, which are initially highly effective, quickly evaporate and provide no after treatment protection against re-growth.

Previously, hexachlorophene was widely used in many preparations to kill bacteria on contact and to prevent growth of bacteria and fungus. Hexachlorophene was included in deodorant compositions, talcum preparations, foot powders, and the like. However, the hexachlorophene when used in direct contact with the skin was absorbable. Prolonged exposure to hexachlorophene was considered as being hazardous and it was withdrawn from use in such compositions.

There is a need to provide film-forming compositions, which are used on or near body parts for preventing bacterial and fungal growth, which does not adversely affect the user.

French Patent No. 2,695,297 discloses a method of disinfecting comprising using a composition containing citric acid, diaminetetracetic acid and a polymeric biguanide salt.

Japanese Patent No. 1989-22824, discloses a medicament for external use that is fungicidal and exhibits an antibacterial spectrum. The medicament comprises quaternary ammonium salts of polymeric carboxylic acid compounds which are sparingly soluble in water. However, the active component is utilized for its ability to permeate into the cutaneous stratum corneum so that such use cannot be continuous and without medical supervision.

U.S. Pat. No. 4,332,763 to Hempel et al discloses the use of a quaternary ammonium polymer obtained by the reaction of dimethyl sulphate with a mixed polymer of vinyl pyrrolidone and dimethylamino ethylmethacrylate. However, the quaternary ammonium cation of this polymer is leachable and the polymer is slightly soluble so that polymer cannot be used in compositions which contact the skin or where long term use is required.

U.S. Pat. No. 3,872,128 to Byck, which is herein incorporated by reference, discloses anti-microbial ammonium polymer salts which prepared from carboxyl-containing α-olefin polymers and quaternary ammonium salts. The polymers are used to form solid polymeric articles for hospitals and patient care. The compounds do not form antimicrobial films.

U.S. Pat. No. 4,946,672 to Gilbs discloses a disinfectant comprising a biguanide, citric acid and other components.

U.S. Pat. No. 3,404,134 to Rees, which is herein incorporated by reference discloses a process for crosslinking copolymers of alpha olefin and alpha, beta ethylenically unsaturated carboxylic acid units. The copolymers are crosslinked utilizing diamine cations. None of the diamine cations are stated as being anti-microbial. Furthermore, the polymers are used to make molded articles and sheet material.

The term “polycarboxylic acid” is intended to mean carboxylic acid compounds having 2-4 carboxylic acid groups or anhydrides which reacted behave as polycarboxylic acids salts thereof.

### SUMMARY OF THE INVENTION

The invention provides novel antimicrobial film forming compositions containing complexes which are formed between polycarboxylic acids and non-benzyl containing biocides, having at least one quaternary ammonium or amine site, preferably two, or the salts thereof and phenols. The reactions between these functional compounds and the carboxylic acid causes at least one of the quaternary ammonium groups to coordinate or complex per molecule or polycaboxylic acid to form a higher molecular weight compound. These higher molecular weight species possess the full activity of the smaller unreacted functional molecule and do not penetrate the skin. It has been surprisingly found that these quaternary compounds form complexes with phenols so as to provide a longer term of antimicrobial activity of the phenols.

Advantageously, antimicrobial long lasting films can be formed with polymers and monomers and the compositions of the invention.

Where the complex with the phenol compound is placed in water or a lower alkanol having less than four carbon atoms as a carrier, there is a multiplicity of antimicrobial activity. The alkanol evaporates, the phenol and phenol complexes are in greater concentration so as to provide the second antimicrobial activity. After the free phenols are released, the film foming complexes continue their activity and retards colonization of microbes.

It is therefore an object of the invention to provide a phenol containing long lasting anti-microbial composition.

It is a further object of the invention to provide an anti-microbial compositon having a broad spectrum of anti-microbial activity.

It is another object of the invention to provide a composition for combating mold and mildew.

### DESCRIPTION OF THE PREFERRED EMBODIMENTS

In accordance with the present invention there is provided novel compositions which contain a plurality of complexes including one formed between polycarboxylic acids and non-benzyl containing functional biocides, all having at least one amine site, preferably two.

The reaction between these functional or useful compounds containing the quaternary amine sites and polycarboxylic acids causes at least one functional molecule to coordinate or complex (react) per molecule of polycarboxylic acid, This forms a higher molecular weight molecule. These higher molecular weight species possess the full activity of the smaller unreacted functional molecule but are more hypoallergenic. The formation of these simple but larger complexes has the effect of creating a slower release type of functional compound and phenol. A complex is also formed with the quaternary ammonium site and the phenol. Therefore, a larger lasting effect is achieved with these complexes without having to use the microbial agent in higher doses or frequent doses.

Benzyl containing antimicrobial quaternary amine compounds are environmentally not suitable.

The preferred antimocrobial quaternary ammonium compounds used in the invention are the ADOGEN series sompounds sold by Witco Corp. of Dublin Ohio. The compounds include 1, 3-propanediamine, N-9-octadecenyl (ADOGEN 572); N, N, N, N₁, N₁-pentamethyl N1-tallow-N alkyl-1,3-propanediamine; (ADOGEN 477), oleylamine; methyltrialkyl (C₈-C₁₀) amine or ammonium chloride (ADOGEN 464) and N-tallow pentamethyl propane diammonium chloride. Either the free amine or the salt thereof can be utilized in an amount of about 0.4 to 10% by weight of the composition.

The composition of the invention can contain all complexes, namely, complexes between the polycarboxylic acids and the quaternary amines compounds and phenols. Also, complexes of the phenols and the quaternary amines when stoichirometric amounds are formed which also forms a film. Excess amounts of the phenols and the quaternary amitnes provides initial killing power for hard to kill pathogens. The mixture in combination with an alcohol provides a still further killing power. The evaporation of the free phenol or amine and alcohol leaves a film which is non-toxic and can be used in food handling areas without washing.

The use of known phenolic compounds such as phenol and 0-phenylphenol in an amount of about 0.4 to 10% by weight of composition of each provides a broad spectrum of kill in combination with the other complexes and components of the invention.

The use of the high amounts of phenol compounds are particularly useful for aqueous compositions that are sprayed into air ducts and vents which are considered as sources for the spread of disease. The phenols not only provide their own antimicrobial activity but improve the antimicrobial capabilities of a film tacky so that the composition adheres to surfaces which are moist or dirty. This feature is especially useful in installations where there is no cleaning or maintenance of the ducts or vents. The phenols further pick up moisture from the air after the initial water evaporates so as to keep the film tacky for longer periods of time. The tacky film holds in the phenols and provides a slow release of phenolic vapors.

After the phenols have evaporated, the film complexes of the invention not only provides a surface which prevents regrowth of viruses, bacteria and fungus but still retains the antimicrobial activity of the base quaternary compound.

Polycarboxylic acids useful in the invention contain 2-4 carboxylic acids groups and include: succinic, acrylic, carboxymethyl cellulose, methacrylic, ethacrylic, itaconic, maleic, fumaric, citric, oxalic, and the like. The salts thereof with anions such as citrates, succinates, fumarates, maleates, malonates, malates, etc. can be used. Maleic anhydride and other anhydrides are considered acids for the purposes of the present invention. The succinic acid is the most preferred complexing agent. Sufficient polycarboxylic acid is used to form a complex with the quaternary ammonium compounds and the phenol.

The complex with a polycarboxylic acid and quaternary ammonium compound of the invention can be generally prepared as follows:

A solution of the polycarboxylic acid in water or water-alcohol is formed either as the ammonium or sodium salt with ammonium or sodium hydroxide, respectively. The anti-microbial compound is dissolved in water or a water-soluble solvent. The molecular ratio of anti-microbial compound to sodium or ammonium carboxylate groups in the acid or mixture of acids is adjusted to one or less than one by varying the quantity of solution to be added to the acid solution. The appropriate amounts of the two solutions are mixed with stirring. The complex forms quickly. This complex can be treated with a phenol compound added directly into the composition. After the complexes are formed, additional phenols and amine compounds can be added.

Any of the phenolic compounds which are antimicrobial can be used. It is preferable to use two different phenols so as to have a broader spectrum of antimicrobial activity. Preferred phenols are 0-phenylphenol, paratertiary amyl phenol and phenol. The chlorinated phenols can also be used but they are environmentally unacceptable.

It is understood that the term “quaternary amine” includes the free amine.

The complexes are soluble in water or alcohol. Alcohols as a group possess many desirable features for disinfecting. However, pure alcohol is not as effective as a mixture of alcohol and water. The compositions of the invention can be admixed with alcohol or water soluble polymers or monomers to form antimicrobial films or fibers. Also the compositions can be sprayed or can treat fibers, clothing, paper and the like to provide antimicrobial barriers. The polymers or monomers can be thermosetting or thermoplastic depending on the use. The compositions can be incorporated into the fibers or films at the time of formiing or can be later sprayed or have the articles dipped into a polymer containing the composition. The amount of polymer utilized depends upon the type of film and thickness required. The acrylic polymers sold by Rohm and Haas of Philadelphia, Pa. Under the trademark EUDRAGIT can be water soluble or water insoluble. Other polymers include olefenic polymers such as polyethylene, polypropylene and the like, ionomers, cellulosic compositions, polycarbonate and the like. The preferred alcohols are methyl, ethyl, and isopropyl alcohol.

The following examples are illustrative of the invention but are not to be construed as to limiting the scope thereof in any manner. The percentage disclosed herein relates to percentages by weight unless otherwise stated.

### EXAMPLE 1

Step A. The following ingredients were mixed:

| | |
|---|---|
| Ingredients | Wt % |

| | |
|---|---|
| Ethyl alcohol | 86.5 |
| Succinic Acid | 2.5 |
| Phenol (90%) | 0.5 |
| Adogen (572) | 2.0 |
| Water | 8.0 |

A complex is formed between succinic acid and Adogen and the phenol and Adogen complex.

Step B. To the mixture of Step A were added the following:

| Ingredients | Wt % |
|---|---|
| 0-phenylphenol | 0.5 |

100%

The combination of Step A alone is suitable for use as an antimicrobial composition. However, the combination of Steps A and B provide a composition having a broad spectrum of antimicrobial activity which lasts for at least 28 days.

The pH of the mixture was 6.5. In lieu of ethyl alcohol, water may be utilized especially when the composition is to be used in vents and ducts. Additional phenol may be added so that the resulting film is tacky for use in the vents and ducts.

The composition kills mildew on contact. A fragrance of about 0.1 to 1% by weight may be added.

### EXAMPLE 2

A sanitizing composition for vents and ducts can be prepared by admixing the following ingredients:

| Ingredients | Wt % |
|---|---|
| Water | 88.0 |
| Succinic Acid | 5.0 |
| Phenol (90%) | 2.0 |
| Adogen | 3.0 |
| O-phenylphenol | 2.0 |

100%

In lieu of succinic acid there may be used citric acid.

The addition of about 0.5% of d-limonene provides fragrance and additional killing strength.

### EXAMPLE 3

The composition of Example 1 was admixed with about 5% of EUDREGIT® an acrylic polymer composition of Rohm and Haas of Philadelphia to produce a sprayable thin transparent film to cover surfaces including garments to form an antimicrobial barrier.

What is claimed is

1. A film forming antimicrobial compositon formed by admixing:
a) about 0.4 to 10% by weight of phenol;
b) about 0.4 to 10% by weight of a phenol selected from the group consisting of o-phenylphenol and chlorinated phenol;
c) about 0.4 to 10% by weight of a polycarboxylic acid having 2 to 4 carboxylic acid groups;
d) about 0.4 to 10% by weight of a compound having at least one amine group selected from the group consisting of 1, 3-propanediamine, N-9-octadecenyl, N, N, N, N₁, N₁-pentamethyl-N-tallow-N-alkyl-1, 3-propanediamine, methylytrialkyl (C₆-C₁₀)-amine, oleyl amine and pentamethyl propane diammonium salt, the free amines or acid addition salts thereof; and
e) a solvent selected from the group consisting of water and an alkanol of 2-4 carboxylic acid groups as the remainder.

2. The composition of claim 1 wherein the polycarboxylic acid is selected from the group consisting of succinic, citric, and tartaric.

3. The composition of claim 1 in which the phenol of Group b is o-phenylphenol.

4. The composition of claim 1 in which the compound of Group d) is 1, 3-propanediamine, N-9-octadecenyl.

5. The composition of claim 1 wherein the solvent comprises ethanol.

6. The composition of claim 1 including a fragrance.

7. The composition of claim 1 wherein said fragrance is d-limonene.

8. The composition of claim 1 including non-complex phenol.

9. The composition of claim 1 including a non-complex member of Group b.

10. The composition of claim 1 including a non-complexed member of group d.

11. An antimicrobial composition containing antimicrobial complexes formed by the admixture comprising:
a) about 0.4 to 10% by weight phenol;
b) about 0.4 to 10% by weight o-phenylphenol;
c) about 0.4 to 10% by weight of succinic acid;
d) about 0.4 to 10% by weight of 1, 3-propanedamine, N-9-octadecenyl; and
e) the remainder a solvent selected from the group consistin of ethanol and water.

12. A combination of the composition of claim 1 and a polymer capable of forming a fiber or a film.

13. The combination of claim 12 wherein said polymer is an acrylic polymer.

14. The combination of the composition of claim 12 and a cellulosic polymer.

15. The combination of the composition of claim 11 and a polymer capable of forming a fiber or a film.

16. The combination of claim 15 wherein said polymer is an acrylic polymer.
